(19) United States
(12) Patent Application Publication
(10) Pub. No.: US 2026/0228685 A1
(43) Pub. Date: Aug. 6, 2026

(54) PLANOGRAM DATA UPDATE APPARATUS, PLANOGRAM DATA UPDATE METHOD, AND COMPUTER-READABLE MEDIUM

(71) Applicant: NEC Corporation, Tokyo (JP)

(72) Inventors: Syunsuke YAMAMOTO, Tokyo (JP); Soma SHIRAISHI, Tokyo (JP); Yaeko YONEZAWA, Tokyo (JP); Yuji TAHARA, Tokyo (JP); Naohiro HAYASHI, Tokyo (JP); Azusa NAGASAWA, Tokyo (JP); Ryosuke SAKAI, Tokyo (JP); Tomokazu KANEKO, Tokyo (JP); Takami SATO, Tokyo (JP)

(73) Assignee: NEC Corporation, Tokyo (JP)

(21) Appl. No.: 19/146,253

(22) PCT Filed: Mar. 28, 2023
(86) PCT No.: PCT/JP2023/012522

§ 371 Date: Jul. 8, 2025

(51) Int. Cl. G06Q 10/087; G06V 10/25; G06V 20/52

(52) U.S. Cl. CPC G06Q 10/08724; G06V 10/25; G06V 20/52

(57) ABSTRACT

Please delete the Abstract of the Disclosure, and replace it with the following:

A region determination unit performs object detection with respect to an image acquired by imaging a shelf on which objects are arranged and, on the basis of the result of the object detection, determines, for each object, a region in which the object is disposed. A non-match region identification unit compares a first region determination result that is based on a first image and a second region determination result that is based on a second image, and identifies a non-match region, which is a region in which objects detected in the first and second images do not match each other. A shelving allocation data update unit updates shelving allocation data on the basis of the second region determination result and the identified non-match region.

### TECHNICAL FIELD

The present disclosure relates to a planogram data update apparatus, a planogram data update method, and a computer-readable medium.

### BACKGROUND ART

As a related art, PTL 1 discloses a product identification system. In a product identification system disclosed in PTL 1, a management terminal executes trapezoid correction processing on a captured image obtained by capturing an image of a display shelf of products, and converts the captured image into a front-facing image that is an image obtained by capturing the product shelf from a front. The management terminal compares image information of a face in a second front-facing image with image information of a face in a predetermined range in a first front-facing image associated to the former face, thereby identifying product identification information of a product on the face in the second front-facing image.

More specifically, the management terminal identifies a region in which the product is placed, that is, a face, for each shelf tier in the front-facing image information. In an initial identification of the product identification information, the management terminal identifies the product identification information of the product displayed on the face by matching the image information of the face with sample image information of the product for each face. In an Nth identification of the product identification information, the management terminal determines similarity between image information of a face in an Nth front-facing image and image information of a face in an N−1th front-facing image information associated to the former face. For a face having low similarity, the management terminal identifies the product identification information by executing image matching processing with the image information of a region of the face and the sample image information.

### CITATION LIST

### Patent Literature

PTL 1: JP 2019-008622 A

### SUMMARY OF INVENTION

### Technical Problem

In a retail store, planogram data obtained by converting a place where each product is displayed into data is data essential for stock-out detection and product replenishment. The planogram is appropriately changed depending on various circumstances of the store. In a case where the planogram is changed, it is necessary to update the planogram data each time. If the update of the planogram data is manually performed, it takes time and effort, and there is a concern that the change may be overlooked.

In PTL 1, identification information of displayed products is identified for each face. However, PTL 1 discloses that a product is identified for each face, but does not disclose that a place displayed for each product is digitized. Therefore, in PTL 1, when the planogram has been changed, the product after the change can be identified, but the planogram data is not changed.

In view of the above circumstances, an object of the present disclosure is to provide a planogram data update apparatus, a planogram data update method, and a computer-readable medium capable of updating planogram data based on images acquired in time series.

### Solution to Problem

In order to achieve the above object, the present disclosure provides, as a first aspect, a planogram data update apparatus. A planogram data update apparatus includes a region determination unit that performs object detection on an image acquired by capturing an image of a shelf on which objects are arranged, and performs region determination for determining a region in which the object is arranged for each object based on a result of the object detection, a mismatch region identification unit that compares a first region determination result that is a result of the region determination for a first image acquired by capturing the image of the shelf at a first time with a second region determination result that is a result of the region determination for a second image acquired by capturing the image of the shelf at a second time that is a time later than the first time, and identifies a mismatch region that is a region in which the objects detected in the first image and the second image do not match, and a planogram data update unit that updates planogram data of the shelf based on the second region determination result and the mismatch region.

As a second aspect, the present disclosure provides a planogram data update method. A planogram data update method includes acquiring a first region determination result by performing object detection on a first image acquired by capturing an image of a shelf on which objects are arranged at a first time, and determining a region in which the object is arranged for each object based on a result of the object detection, acquiring a second region determination result by performing object detection on a second image acquired by capturing the image of the shelf at a second time that is a time later than a first time, and determining a region in which the object is arranged for each object based on a result of the object detection, identifying a mismatch region that is a region where the objects detected in the first image and the second image do not match by comparing the first region determination result with the second region determination result, and updating the planogram data of the shelf based on the second region determination result and the mismatch region.

The present disclosure provides a computer-readable medium as a third aspect. A computer-readable medium stores a program causing a computer to execute processing of acquiring a first region determination result by performing object detection on a first image acquired by capturing an image of a shelf on which objects are arranged at a first time, and determining a region in which the object is arranged for each object based on a result of the object detection, acquiring a second region determination result by performing object detection on a second image acquired by capturing the image of the shelf at a second time that is a time later than a first time, and determining a region in which the object is arranged for each object based on a result of the object detection, identifying a mismatch region that is a region where the objects detected in the first image and the second image do not match by comparing the first region determination result with the second region determination result, and updating the planogram data of the shelf based on the second region determination result and the mismatch region.

### Advantageous Effects of Invention

The planogram data update apparatus, the planogram data update method, and the computer-readable medium according to the present disclosure can update the planogram data based on images acquired in time series.

### BRIEF DESCRIPTION OF DRAWINGS

FIG. 1 is a block diagram illustrating a schematic configuration example of a planogram data update apparatus according to the present disclosure.

FIG. 2 is a block diagram illustrating a planogram data update apparatus according to an example embodiment of the present disclosure.

FIG. 3 is a schematic diagram illustrating an example of a result of region determination performed on a first image.

FIG. 4 is a schematic diagram illustrating an example of a result of region determination performed on a second image.

FIG. 5 is a schematic diagram illustrating a specific example of a matching degree of regions.

FIG. 6 is a schematic diagram illustrating a specific example of a result of identifying a mismatch region.

FIG. 7 is a schematic diagram illustrating a specific example of planogram data before update.

FIG. 8 is a schematic diagram illustrating a specific example of planogram data after update.

FIG. 9 is a flowchart illustrating an operation procedure of the planogram data update apparatus.

FIG. 10 is a block diagram showing an example of a configuration of a computer apparatus.

### EXAMPLE EMBODIMENT

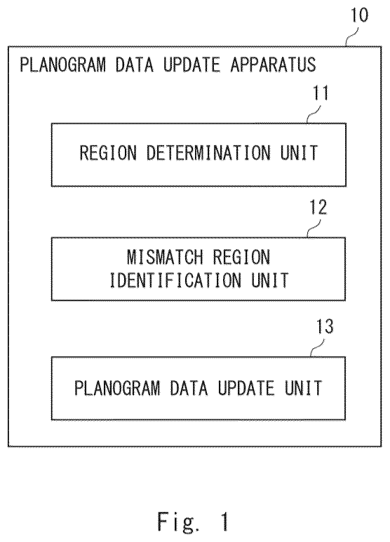

Prior to describing example embodiments of the present disclosure, an overview of the present disclosure will be given. FIG. 1 illustrates a schematic configuration example of a planogram data update apparatus according to the present disclosure. A planogram data update apparatus 10 includes a region determination unit 11, a mismatch region identification unit 12, and a planogram data update unit 13.

The region determination unit 11 performs object detection on an image acquired by capturing an image of a shelf on which objects are arranged. The region determination unit 11 determines a region in which the object is arranged for each object based on a result of the object detection. The region determination unit 11 performs region determination on a first image acquired by capturing an image of the shelf at a first time, and outputs a first region determination result. The region determination unit 11 performs region determination on a second image acquired by capturing an image of the shelf at a second time, and outputs a second region determination result. The second time is a time later than the first time.

The mismatch region identification unit 12 compares the first region determination result with the second region determination result, and identifies a mismatch region which is a region where objects detected in the first image and the second image do not match. The planogram data update unit 13 updates the planogram data of the shelf based on the second region determination result and the mismatch region identified by the mismatch region identification unit 12.

In the present disclosure, the mismatch region identification unit 12 compares the results of the region determinations at the two times, and identifies a mismatch region that is a region where the objects detected in the first image and the second image do not match. A region in which the detected objects do not match between the first image and the second image acquired in time series is a region in which the planogram may have been changed. The planogram data update unit 13 updates the planogram data for such a region. In this manner, the planogram data update apparatus 10 according to the present disclosure can update the planogram data based on the images acquired in time series.

Hereinafter, the example embodiments of the present disclosure will be described in detail with reference to the drawings. In the following description and drawings, omission and simplification are made as appropriate for clarity of description. In the following drawings, the same elements and the same elements are denoted by the same reference numerals, and redundant description will be omitted as necessary.

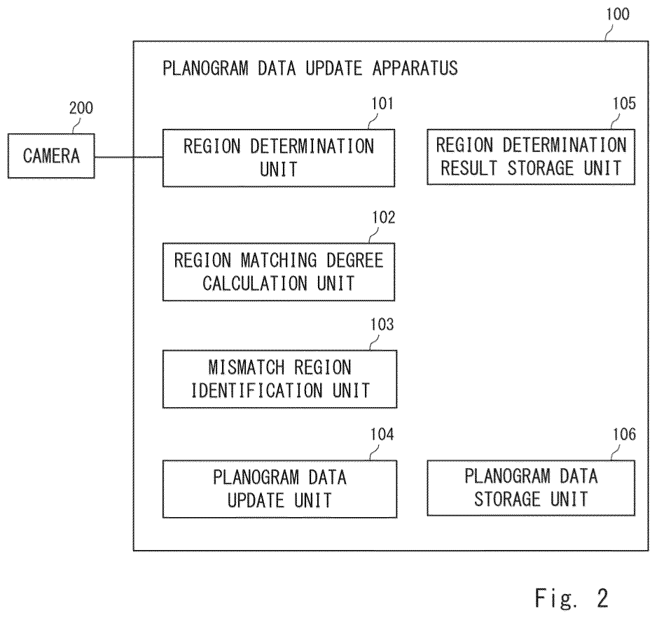

FIG. 2 illustrates a planogram data update apparatus according to an example embodiment of the present disclosure. The planogram data update apparatus 100 includes a region determination unit 101, a region matching degree calculation unit 102, a mismatch region identification unit 103, a planogram data update unit 104, a region determination result storage unit 105, and a planogram data storage unit 106. The planogram data update apparatus 100 can be configured as an apparatus including one or more processors and one or more memories. For example, at least a part of each functional block in the planogram data update apparatus 100 can be achieved by the processor executing processing according to a command read from the memory.

The planogram data update apparatus 100 acquires an image captured by the camera 200 from the camera 200. In the present example embodiment, the camera 200 is assumed to be a camera that captures an image of a shelf on which objects such as products are displayed. The camera 200 is installed in a place such as a ceiling of a selling region of a store, for example, and captures an image of a shelf on which products are displayed, that is, a product shelf, in the selling region. For example, the planogram data update apparatus 100 periodically acquires an image of a product shelf captured by the camera 200. The image acquired by the planogram data update apparatus 100 includes a first image captured at a first time and a second image captured at a second time that is a time later than the first time.

The region determination unit 101 performs object detection on the image acquired from the camera 200. For example, the region determination unit 101 performs object detection on an image of a shelf on which products are displayed, and detects the products displayed on the shelf. The region determination unit 101 determines, for each detected object, a region in which the object is arranged based on the result of the object detection. For example, the region determination unit 101 determines a region in which the products are arranged on the shelf by merging regions or frames in which the same products are continuous on the shelf. The region determination unit 101 performs region determination on each of the first image and the second image. The region determination unit 101 stores the region determination result in the region determination result storage unit 105.

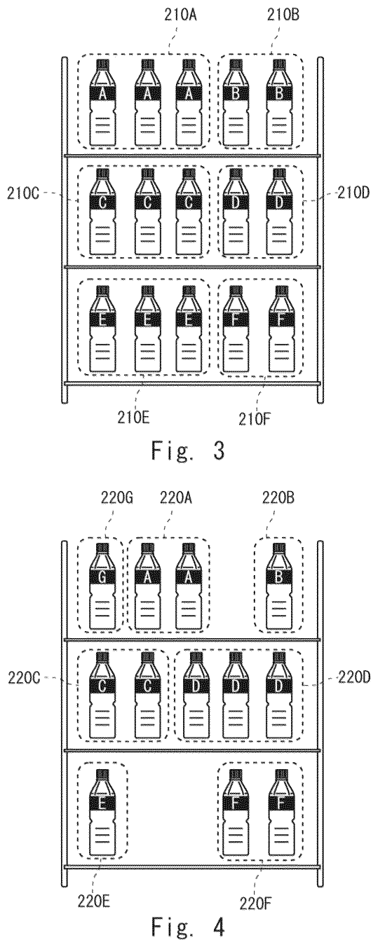

FIG. 3 illustrates an example of a result of the region determination performed on the first image. In this example, it is assumed that the product displayed on the shelf is a plastic bottle beverage. Six types of products A to F are displayed on the shelf. The region determination unit 101 performs, for example, object detection on the first image, and individually detects regions in which the products A to F are arranged. The region determination unit 101 merges individual product regions in which the same products are successively arranged, and determines regions 210A to 210F in which each product is arranged. The region determination unit 101 stores, for example, coordinates of the regions 210A to 210F in which the products A to F are arranged, for example, a set of upper left coordinates and lower right coordinates of a region represented by a rectangle in the region determination result storage unit 105 as a first region determination result.

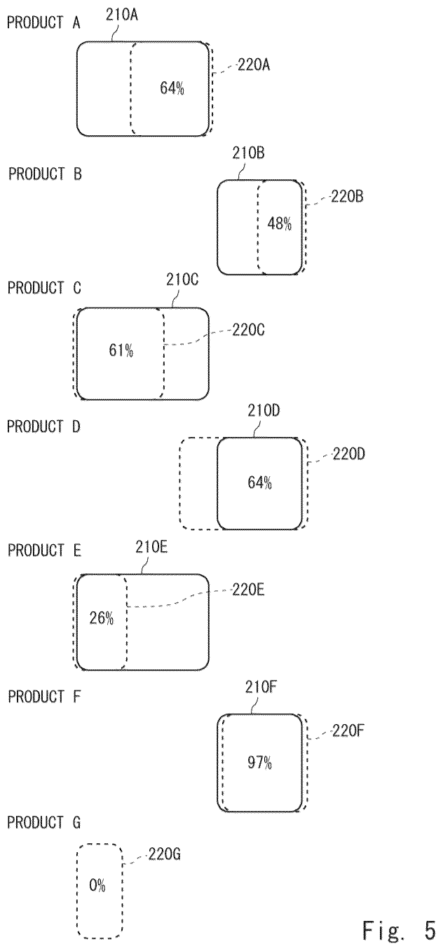

FIG. 4 illustrates an example of a result of the region determination performed on the second image. After the first image is acquired, some products sell well in such a way that there is a region where no product is detected in the second image. After the first image is acquired, there is a product G that has not been displayed at the time when the first image has been acquired. The region determination unit 101 performs object detection on the second image and individually detects regions in which the products A to G are arranged. The region determination unit 101 merges individual product regions in which the same products are successively arranged, and determines regions 220A to 220G in which each product is arranged. The region determination unit 101 stores, for example, coordinates of the regions 220A to 220G in which the products A to G are arranged, for example, a set of upper left coordinates and lower right coordinates of a region represented by a rectangle in the region determination result storage unit 105 as a second region determination result.

The region matching degree calculation unit 102 compares the first region determination result with the second region determination result, and calculates the region matching degree for each object, that is, each product. For example, the region matching degree calculation unit 102 calculates, as the matching degree, a ratio of an area of a portion where the regions overlap with each other, that is, a common portion with respect to an area of a union of a region of the product in the first region determination result and a region of the product in the second region determination result. For example, the region matching degree calculation unit 102 calculates an intersection over union (IoU), which is an index indicating how much the two regions overlap with each other, for the region of each product in the first region determination result and the region of each product in the second region determination result.

The region matching degree calculation unit 102 calculates the region matching degree for each of products detected from both the first image and the second image, products detected only from the first image, and products detected only from the second image. For a certain product, in a case where the matching degree of the region of the product is less than a predetermined threshold, it can be determined that there is a possibility that the planogram has been changed, that is, the number of faces has increased or decreased. On the other hand, in a case where the matching degree is equal to or more than the threshold, it is considered that the planogram is not changed. Therefore, it is not necessary to update the planogram data for the product having a high matching degree.

FIG. 5 illustrates a specific example of the matching degree between the region of each product in the first region determination result and the region of each product in the second region determination result. The region matching degree calculation unit 102 calculates a matching degree between regions 210A to 210F in the first region determination result and regions 220A to 220G in the second region determination result for each of the products A to G. The region matching degree calculation unit 102 calculates the ratio of the area of the common portion to the area of the union of the region 210A in the first region determination result and the region 220A in the second region determination result as the matching degree for the product A. The region matching degree calculation unit 102 also calculates the ratio of the area of the common portion to the area of the union of the two regions as the matching degree for other products.

As illustrated in FIG. 5, the region matching degree calculation unit 102 calculates that the matching degree between the region 210A and the region 220A is 64% for the product A. The region matching degree calculation unit 102 calculates that the matching degrees of the regions 210B to 210F and the regions 220B to 220F are 48%, 61%, 64%, 26%, and 97%, for the products B to F, respectively. For the product G, since there is no region of the product G in the first region determination result, the region matching degree calculation unit 102 calculates the matching degree as 0%. It is assumed that the matching degree of the region of the product F among the products A to G is 97%, and the matching degree is equal to or more than a predetermined threshold. In that case, for the product F, it can be determined that the planogram has not been changed in a period between a time when the first image has been acquired and a time when the second image has been acquired.

The mismatch region identification unit 103 compares the first region determination result with the second region determination result, and identifies a mismatch region which is a region where the objects detected in the first image and the second image do not match. For example, the mismatch region identification unit 103 identifies a mismatch region for a product whose matching degree of regions is less than the predetermined threshold between the first region determination result and the second region determination result. For a product having a high matching degree between the first region determination result and the second region determination result, it is considered that the face has not increased or decreased. Therefore, the mismatch region identification unit 103 may not specify the mismatch region for the product having a high matching degree.

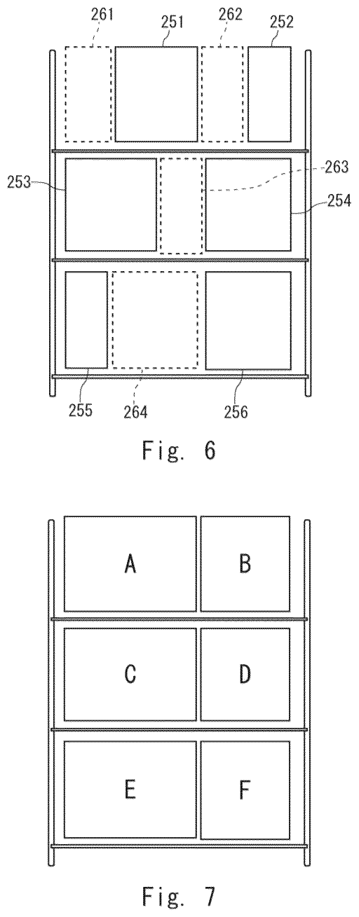

FIG. 6 illustrates a specific example of a result of identifying a mismatch region. The mismatch region identification unit 103 compares the regions 210A to 210F (see FIG. 3) of the products A to F in the first region determination result with the regions 220A to 220G (see FIG. 4) of the products A to G in the second region determination result, and identifies a mismatch region. The mismatch region identification unit 103 identifies, as matching regions 251 to 256, regions of portions common to both the region determination results among the regions of the respective products. The mismatch region identification unit 103 identifies, as mismatch regions 261 to 264, regions of portions that are not common in both the region determination results among the regions of the respective products. The identification of the mismatch region in the mismatch region identification unit 103 and the calculation of the matching degree of the regions in the region matching degree calculation unit 102 may be performed simultaneously.

The planogram data storage unit 106 stores planogram data of a shelf captured by the camera 200. The planogram data includes, for example, a list of products to be arranged on the shelf and information indicating a region of the shelf where each product is arranged. It is assumed that, at the time when the second image is acquired, the planogram data storage unit 106 stores planogram data updated at the time when the first image is acquired.

An initial value of the planogram data may be automatically generated from, for example, the region determination result of the region determination unit 101 at the start of operation. For example, at the start of operation, the camera 200 acquires an image of a shelf in a state where the shelf is filled with products without gaps. The region determination unit 101 performs object detection on the image acquired from the camera 200, and determines a region in which the object is arranged for each detected object. In this example, the result of the region determination at the start of operation may be used as an initial value of the planogram data. Alternatively, the initial value of the planogram data may be manually provided.

The planogram data update unit 104 updates the planogram data stored in the planogram data storage unit 106 based on the second region determination result determined from the second image and the mismatch region identified by the mismatch region identification unit 103. For example, the planogram data update unit 104 updates the planogram data according to whether a product is detected in the mismatch region in the second image. For example, the planogram data update unit 104 determines, for example, whether a product is detected in the second image for each mismatch region identified by the mismatch region identification unit 103. Specifically, for example, the planogram data update unit 104 determines whether an object is detected in the second image for each of the mismatch regions 261 to 264 illustrated in FIG. 6. The planogram data update unit 104 determines which product's region the mismatch region belongs to according to whether the product is detected in the mismatch region.

In a case where a product is detected in the mismatch region in the second image, the planogram data update unit 104 determines that a change in the planogram or an increase or decrease in the number of faces has occurred, and updates the planogram data. In a case where a product is detected in the mismatch region in the second image, the planogram data update unit 104 allocates the product detected in the mismatch region in the second image to the mismatch region in the updated planogram data. In a case where no object is detected in the mismatch region in the second image, the planogram data update unit 104 determines that a mismatch region is generated due to a product stock-out. In this case, the planogram data update unit 104 does not change the product allocated to the mismatch region from the product allocated to the mismatch region in the planogram data at the time when the first image is acquired. The planogram data update unit 104 stores the updated planogram data in the planogram data storage unit 106.

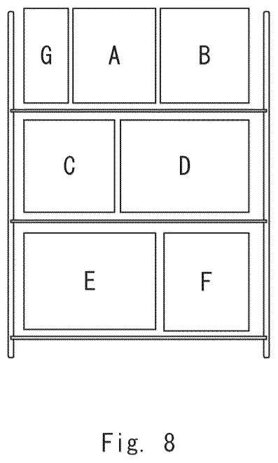

FIG. 7 illustrates a specific example of the planogram data before update. FIG. 8 illustrates a specific example of the updated planogram data. In FIGS. 7 and 8, “A” to “G” indicate to which product among the products A to G the region indicated by a rectangle is allocated. In other words, “A” to “G” indicate which product of the products A to G each region corresponds to. It is assumed that the planogram data before update illustrated in FIG. 7 is planogram data updated or generated at the time when the first image is acquired. With respect to the mismatch region identified by the mismatch region identification unit 103, the planogram data update unit 104 updates the product allocated to the mismatch region according to whether the product is detected in the mismatch region in the second image.

In the planogram data before update illustrated in FIG. 7, for example, the mismatch region 261 illustrated in FIG. 6 is allocated to the product A. The planogram data update unit 104 determines whether a product is detected in the second image for the mismatch region 261. As illustrated in FIG. 4, in the second image, the product G is detected in the mismatch region 261. In other words, the mismatch region 261 overlaps the region 220G of the product G in the second region determination result. In this case, the planogram data update unit 104 changes the product to be allocated to the mismatch region 261 in the planogram data from the product A before update to the product G. Since the product allocated to the mismatch region 261 has been changed, the planogram data update unit 104 reduces the region of the product A by one product in the updated planogram data as illustrated in FIG. 8.

In the planogram data before update illustrated in FIG. 7, the mismatch region 263 illustrated in FIG. 6 is allocated to the product C. The planogram data update unit 104 determines whether a product is detected in the second image for the mismatch region 263. As illustrated in FIG. 4, in the second image, the product D is detected in the mismatch region 263. In other words, the mismatch region 263 overlaps the region 220D of the product D in the second region determination result. In this case, the planogram data update unit 104 changes the product to be allocated to the mismatch region 261 in the planogram data from the product C before update to the product D. In this case, as illustrated in FIG. 8, in the updated planogram data, the region of the product D is enlarged by one product, and the region of the product C is reduced by one product.

In the planogram data before update illustrated in FIG. 7, the mismatch regions 262 and 264 illustrated in FIG. 6 are allocated to the product B and the product E, respectively. The planogram data update unit 104 determines whether a product has been detected in the second image for each of the mismatch regions 262 and 264. As illustrated in FIG. 4, no product is detected in the mismatch regions 262 and 264 in the second image. In this case, the planogram data update unit 104 does not change the product allocated to each of the mismatch regions 262 and 264 in the planogram data from the product B and the product D before update. For the product F, since the matching degree of the region calculated by the region matching degree calculation unit 102 is equal to or more than the threshold, there is no change in the region of the product F in the planogram data. The planogram data update unit 104 stores the updated planogram data illustrated in FIG. 8 in the planogram data storage unit 106.

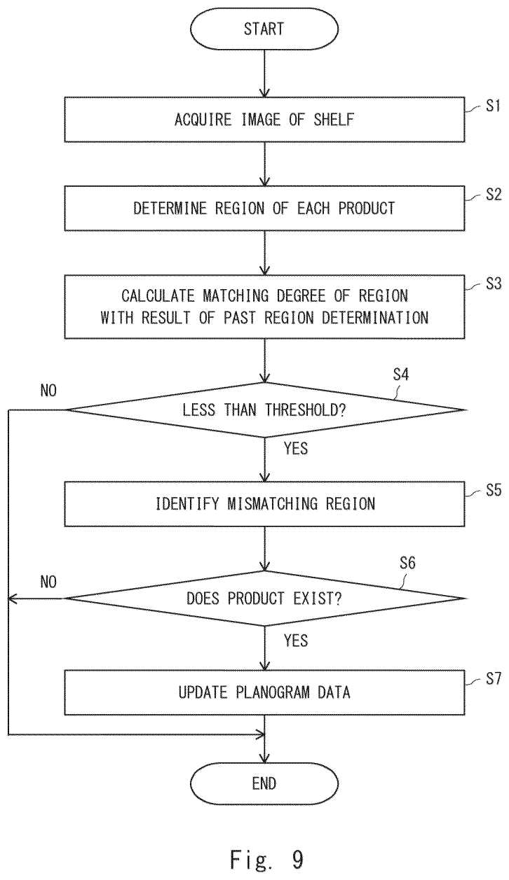

Next, an operation procedure will be described. FIG. 9 illustrates an operation procedure of the planogram data update apparatus 100. The operation procedure of the planogram data update apparatus 100 corresponds to a planogram data update method. The region determination unit 101 acquires an image obtained by capturing an image of a shelf on which products are displayed from the camera 200 (step S1). The region determination unit 101 determines a region of each product displayed on the shelf from the acquired image (step S2). In step S2, for example, the region determination unit 101 detects a product by performing object detection on the image of the shelf acquired from the camera 200, and determines the region of each product by merging the regions of the detected products. The region determination unit 101 stores the region determination result in the region determination result storage unit 105.

The region matching degree calculation unit 102 compares the result of the region determination in step S2 with the result of the region determination performed in the past planogram data update stored in the region determination result storage unit 105, and calculates the matching degree of the regions for each product present on the shelf (step S3). Here, a result of the region determination performed in the past planogram data update is referred to as a first region determination result. The result of the region determination in step S1 is referred to as a second region determination result. In step S3, the region matching degree calculation unit 102 acquires, for example, a result of region determination performed in the previous update of the planogram data as a first region determination result. The region matching degree calculation unit 102 calculates IoU between the region in the first region determination result and the region in the second region determination result for each product.

The mismatch region identification unit 103 determines whether the matching degree of the regions is less than a predetermined threshold for each product (step S4). The mismatch region identification unit 103 identifies a mismatch region for a product whose matching degree of regions is less than the predetermined threshold (step S5). The planogram data update unit 104 determines whether a product exists in the image acquired in step S1 for each identified mismatch region (step S6). The planogram data update unit 104 updates the planogram data for the mismatch region in which it is determined in step S6 that the product exists (step S7). In step S7, the planogram data update unit 104 allocates the mismatch region in which it is determined that the product exists in the planogram data to the product detected from the image acquired in step S1.

The planogram data update unit 104 does not update the planogram data for the product for which it is determined in step S4 that the matching degree between the regions is equal to or more than the threshold. The planogram data update unit 104 does not update the planogram data for the mismatch region in which it is determined in step S6 that the product does not exist. The planogram data update unit 104 stores the updated planogram data in the planogram data storage unit 106.

The user may operate the planogram data update apparatus 100 or another apparatus to display the planogram data stored in the planogram data storage unit 106 on a display screen of a display device. By viewing the displayed planogram data, the user can check whether the actual planogram matches the planogram indicated by the planogram data. The user may manually correct the planogram data stored in the planogram data storage unit 106 by operating the planogram data update apparatus 100 or another apparatus.

In a case where a product allocated to any region is changed in the planogram data, the planogram data update unit 104 may record a change history in the planogram data storage unit 106. In a case where the planogram data stored in the planogram data storage unit 106 is displayed, the planogram data update apparatus 100 or another apparatus may display a frame indicating the region of the product that has been changed in a color different from a color of a frame indicating the region of the product that has not been changed. In that case, the user can know which part has been changed in the update.

In a case where the planogram data is displayed, the planogram data update apparatus 100 or another apparatus may display the planogram data before update and the updated planogram data in a comparable manner. For example, the planogram data update apparatus 100 may display the update planogram data before update illustrated in FIG. 7 and the updated planogram data illustrated in FIG. 8 side by side on the display screen. In addition to the planogram data, the planogram data update apparatus 100 or another apparatus may display an image of the camera 200 used for updating the planogram data on the display screen.

In the displayed planogram data, the user may be able to select any region or product. In a case where the user selects a certain product or a region of the certain product, the planogram data update apparatus 100 or another apparatus identifies a timing at which the planogram data is updated for the product or the region using the update history. The planogram data update apparatus 100 or another apparatus may display the planogram data before update at the identified timing and the updated planogram data in a comparable manner.

In the present example embodiment, the region determination unit 101 performs region determination on the first image acquired at the first time, and acquires a first region determination result. The region determination unit 101 performs region determination on the second image acquired at the second time, and acquires a second region determination result. The mismatch region identification unit 103 compares the first region determination result with the second region determination result, and identifies a mismatch region. The planogram data update unit 104 updates the planogram data based on the second region determination result and the identified mismatch region. In the present example embodiment, the mismatch region identified by the mismatch region identification unit 103 is considered to be related to a region where the planogram has been changed or the number of faces has been increased or decreased. Therefore, the planogram data update apparatus 100 can detect a change in the planogram or an increase or decrease in the number of faces based on the first image and the second image acquired in time series, and can update the planogram data according to the detected change in the planogram or increase or decrease in the number of faces.

In the present example embodiment, the planogram data update unit 104 determines whether a product has been detected in the second image for each identified mismatch region. It is possible to determine whether there is no product in the second image, that is, whether there is out of stock, or whether the product has been replaced by another product according to whether there is a product in the mismatch region in the second image. In the present example embodiment, the planogram data update unit 104 updates the planogram data according to whether a product is detected in the mismatch region in the second image. In this case, the planogram data update unit 104 can appropriately update the planogram data between the region where there is out of stock and the region where a product has been replaced.

In the above example embodiment, an example has been described in which the camera 200 acquires the image of the product display shelf arranged in the selling region in the store. However, the present disclosure is not limited thereto. The camera 200 is not necessarily installed in a store such as a retail store, and for example, the camera 200 may acquire an image of a shelf on which some object is placed in a place other than the store such as a warehouse. In other words, the planogram data update apparatus 100 may be used to update planogram data of an object placed on a shelf in a warehouse.

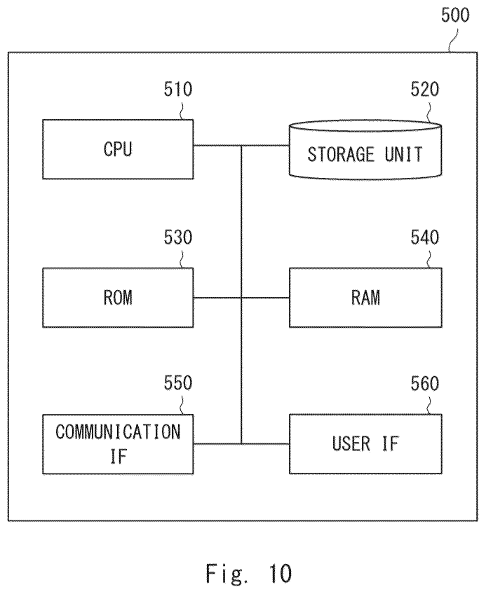

In the present disclosure, the planogram data update apparatus 100 can be configured using a computer apparatus or a server apparatus. FIG. 10 illustrates a configuration example of a computer apparatus that can be used for the planogram data update apparatus 100. A computer apparatus 500 includes a control unit (central processing unit (CPU)) 510, a storage unit 520, a read only memory (ROM) 530, a random access memory (RAM) 540, a communication interface (IF: Interface) 550, and a user interface 560.

The communication interface 550 is an interface connecting the computer apparatus 500 to a communication network through wired communication means, wireless communication means, or the like. The user interface 560 includes, for example, a display unit such as a display. The user interface 560 includes an input unit such as a keyboard, a mouse, and a touch panel.

The storage unit 520 is an auxiliary storage device that can retain various types of data. The storage unit 520 is not necessarily a part of the computer apparatus 500, and may be an external storage device or a cloud storage connected to the computer apparatus 500 via a network. The storage unit 520 can be used as at least one of the region determination result storage unit 105 and the planogram data storage unit 106 (see FIG. 2).

The ROM 530 is a nonvolatile storage device. For example, a semiconductor storage device such as a flash memory that has a relatively compact capacity may be used for the ROM 530. A program that is executed by the CPU 510 may be stored in the storage unit 520 or the ROM 530. The storage unit 520 or the ROM 530 stores, for example, various programs for realizing functions of each unit of the planogram data update apparatus 100.

The program includes a group of instructions (or software code) for causing the computer to perform one or more functions described in the example embodiments when the program is loaded into the computer. The program may be stored in a non-transitory computer-readable medium or in a physical storage medium. As an example and not by way of limitation, a computer-readable medium or a tangible storage medium includes a RAM, a ROM, a flash memory, a solid-state drive (SSD) or any other memory technology, a compact disc (CD), a digital versatile disc (DVD), a Blu-ray® disk or any other optical disk storage, a magnetic cassette, a magnetic tape, a magnetic disk storage, or any other magnetic storage device. The program may be transmitted on a transitory computer-readable medium or a communication medium. Without being limited, but examples of the transitory computer-readable medium or the communication medium include an electric signal, an optical signal, an acoustic signal, or any other form of propagation signal.

The RAM 540 is a volatile storage device. As the RAM 540, various types of semiconductor memory devices such as a dynamic random access memory (DRAM) or a static random access memory (SRAM) may be used. The RAM 540 may be used as an internal buffer that temporarily stores data or the like. The CPU 510 loads a program stored in the storage unit 520 or the ROM 530, in the RAM 540 and executes the loaded program. Functions of the respective units in the planogram data update apparatus 100 can be achieved by the CPU 510 executing the program. The CPU 510 may include an internal buffer in which data or the like can be temporarily stored.

In the above example embodiment, the planogram data update apparatus 100 is not necessarily configured as a single apparatus. The planogram data update apparatus 100 may be configured using a plurality of physically separated apparatuses.

Although the example embodiments of the present disclosure have been described above in detail, the present disclosure is not limited to the above example embodiments, and the present disclosure also includes changes or modifications made to the above example embodiments without departing from the scope of the present disclosure.

### REFERENCE SIGNS LIST

10 planogram data update apparatus
11 region determination unit
12 mismatch region identification unit
13 planogram data update unit
100 planogram data update apparatus
101 region determination unit
102 region matching degree calculation unit
104 planogram data update unit
105 region determination result storage unit
106 planogram data storage unit
500 computer apparatus
510 control unit
520 storage unit
530 ROM
540 RAM
550 communication interface
560 user interface

What is claimed is:

1. A planogram data update apparatus comprising:
at least one memory storing instructions; and
at least one processor configured to execute the instructions to:
perform object detection on an image acquired by capturing an image of a shelf on which objects are arranged, and perform performs-region determination for determining a region in which the object is arranged for each object based on a result of the object detection;
compare a first region determination result that is a result of the region determination for a first image acquired by capturing the image of the shelf at a first time with a second region determination result that is a result of the region determination for a second image acquired by capturing the image of the shelf at a second time that is a time later than the first time, and identify a mismatch region that is a region in which the objects detected in the first image and the second image do not match; and
update planogram data of the shelf based on the second region determination result and the mismatch region.

2. The planogram data update apparatus according to claim 1, wherein the at least one processor is configured to execute the instructions to determine whether to update the planogram data according to whether an object is detected in the mismatch region in the second image.

3. The planogram data update apparatus according to claim 2, wherein in a case where an object is detected in the mismatch region in the second image, the at least one processor is configured to execute the instructions to allocate the object detected in the mismatch region in the second image to the mismatch region in the planogram data, and in a case where no object is detected in the mismatch region in the second image, the at least one processor is configured to execute the instructions to not change the object allocated to the mismatch region from the object allocated to the mismatch region in the planogram data at the first time.

4. The planogram data update apparatus according to claim 1, wherein the at least one processor is configured to execute the instructions to:
compare the first region determination result with the second region determination result and calculate a matching degree of a region in which the object is arranged for each object; and
identify the mismatch region for an object of which a matching degree of the regions is less than a predetermined value.

5. The planogram data update apparatus according to claim 4, wherein the at least one processor is configured to execute the instructions to calculate, for each object, a ratio of an area of a common portion between the region in the first region determination result and the region in the second region determination result to an area of a union of the region in the first region determination result and the region in the second region determination result as a matching degree.

6. A planogram data update method comprising:
acquiring a first region determination result by performing object detection on a first image acquired by capturing an image of a shelf on which objects are arranged at a first time, and determining a region in which the object is arranged for each object based on a result of the object detection;
acquiring a second region determination result by performing object detection on a second image acquired by capturing the image of the shelf at a second time that is a time later than a first time, and determining a region in which the object is arranged for each object based on a result of the object detection;
identifying a mismatch region that is a region where the objects detected in the first image and the second image do not match by comparing the first region determination result with the second region determination result; and
updating the planogram data of the shelf based on the second region determination result and the mismatch region.

7. The planogram data update method according to claim 6, wherein updating the planogram data further comprises determining whether to update the planogram data according to whether the object is detected in the mismatch region in the second image.

8. A non-transitory computer-readable medium for storing a program causing a computer to execute processing of:
acquiring a first region determination result by performing object detection on a first image acquired by capturing an image of a shelf on which objects are arranged at a first time, and determining a region in which the object is arranged for each object based on a result of the object detection;
acquiring a second region determination result by performing object detection on a second image acquired by capturing the image of the shelf at a second time that is a time later than a first time, and determining a region in which the object is arranged for each object based on a result of the object detection;
identifying a mismatch region that is a region where the objects detected in the first image and the second image do not match by comparing the first region determination result with the second region determination result; and
updating the planogram data of the shelf based on the second region determination result and the mismatch region.

9. The non-transitory computer-readable medium according to claim 8, wherein updating the planogram data further comprises determining whether to update the planogram data according to whether the object is detected in the mismatch region in the second image.
